(19) United States
(12) Patent Application Publication
(10) Pub. No.: US 2015/0128778 A1
(43) Pub. Date: May 14, 2015

(54) Band Saw Machine Capable of Automatically Regulating Cutting Speed

(71) Applicant: NATIONAL CHUNG CHENG UNIVERSITY, Chia-Yi County (TW)

(72) Inventors: Yeau-Ren JENG, Tainan City (TW); Chih-Chun CHENG, Tainan City (TW); Yu-Xian HUANG, Tainan City (TW)

(73) Assignee: NATINAL CHUNG CHENG UNIVERSITY, Chia-Yi County (TW)

(21) Appl. No.: 14/079,420

(22) Filed: Nov. 13, 2013

(51) Int. Cl. B23D 59/00; B23D 55/00

(52) U.S. Cl. CPC B23D 59/001; B23D 55/00
USPC 83/72

(57) ABSTRACT

A band saw machine includes a chassis, a motor mounted to the chassis, driving wheel mounted to the chassis and connected with the motor, a driven wheel mounted to the chassis, a band saw running on the driving and driven wheels, a band-saw regulator mounted to the chassis and located between the driving and driven wheels, and a vibration sensor mounted to the surface of the band-saw regulator for sensing the vibration of the band-saw regulator generated in the process of cutting and thus emitting a sensing signal to a control system. In this way, the control system can control the rotational sp d of the motor according to the sensing signal received from the vibration sensor to automatically regulate the cutting speed.

### BACKGROUND OF THE INVENTION

1. Field of the Invention

The present invention relates generally to a band saw machine and more particularly, to a band saw capable of automatically regulating cutting speed.

2. Description of the Related Art

Generally speaking, when a user operates a band saw machine, the user needs to regulate the cutting speed of the band saw according to the material property of a workpiece. For example, if the workpiece is wood, which is relatively more soft-textured, it will be necessary to apply higher cutting speed; if the workpicce is a metal, which is relatively more rigid-textured, it will be necessary to apply lower cutting speed. In this way, the band saw can be prevented from rupture.

Taiwan Patent Pub. No. M338123 disclosed that a frequency converter is used to regulate the rotational speed of the motor to indirectly regulate the cutting speed of the band saw and the power frequency or the rotational speed of the motor is shown on a screen. However, the data presented by the frequency inverter does not indicate the actual cutting speed of the band saw and the user's data interpretation may have inaccuracy, so it frequently happens that the cutting speed of the band saw cannot be adjusted most appropriately to further adversely affect the cutting efficiency and service life of the band saw.

### SUMMARY OF THE INVENTION

The primary objective of the present invention is to provide a band saw machine, which can automatically adjust the cutting speed of the band saw to enhance the cutting efficiency and service life of the band saw.

The foregoing objective of the present invention is attained by the band saw machine formed of a chassis, a motor, a driving wheel, a driven wheel, a band saw, a band-saw regulator, a vibration sensor, and a control system. The motor is mounted to the chassis and includes a driving shaft. The driving wheel is rotatably mounted to the chassis and connected with the driving shaft and can be driven by the motor for rotation. The driven wheel is rotatably mounted to the chassis relative to the driving wheel. The band saw runs on the driving and driven wheels for cutting a workpiece. The band-saw regulator is mounted to the chassis, located between the driving and driven wheels, and stopped against the band saw. The vibration sensor is mounted to a surface of the band-saw regulator for sensing the vibration of the band-saw regulator generated in the process of cutting and thus emitting a sensing signal. The control system is electrically connected with the motor and the vibration sensor for receiving the sensing signal and controlling the power output from the motor to the driving wheel.

In light of the structure indicated above, the band saw machine of the present invention can adjust the cutting speed of the band saw in real time to maintain the force required for the cutting of the band saw, thus effectively enhancing the cutting efficiency and service life of the band saw.

### BRIEF DESCRIPTION OF THE DRAWINGS

FIG. 1 is a front view of a preferred embodiment of the present invention.

FIG. 2 is a partially rear view of the preferred embodiment of the present invention.

FIG. 3 is a block diagram of the preferred embodiment of the present invention.

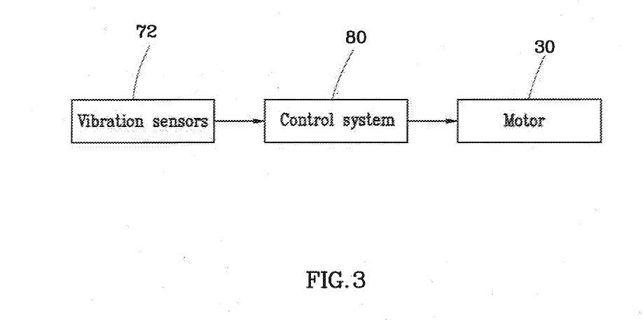

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only thus is not limitative of the claim scope of the present invention.

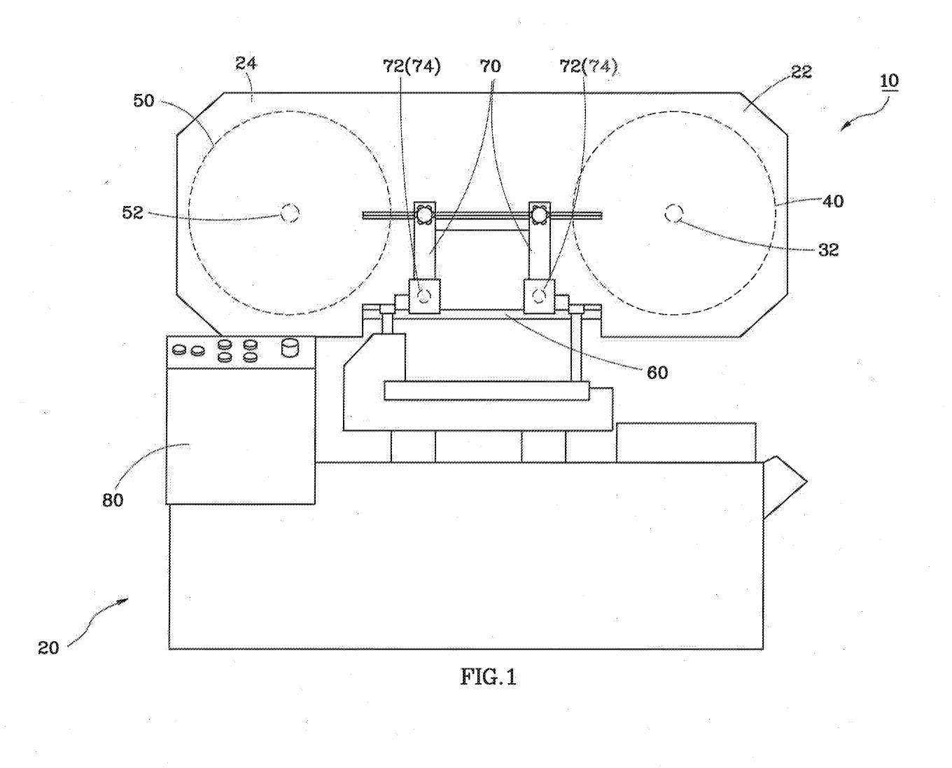

Referring to FIG. 1, the band saw machine 10 of the present invention is formed of a chassis 20, a motor 30, a driving wheel 40, a driven wheel 50, a band saw 60, two band-saw regulators 70, two vibration sensors 80, and a control system 90. The detailed descriptions and operations of these elements as well as their interrelations are recited in the respective paragraphs as follows.

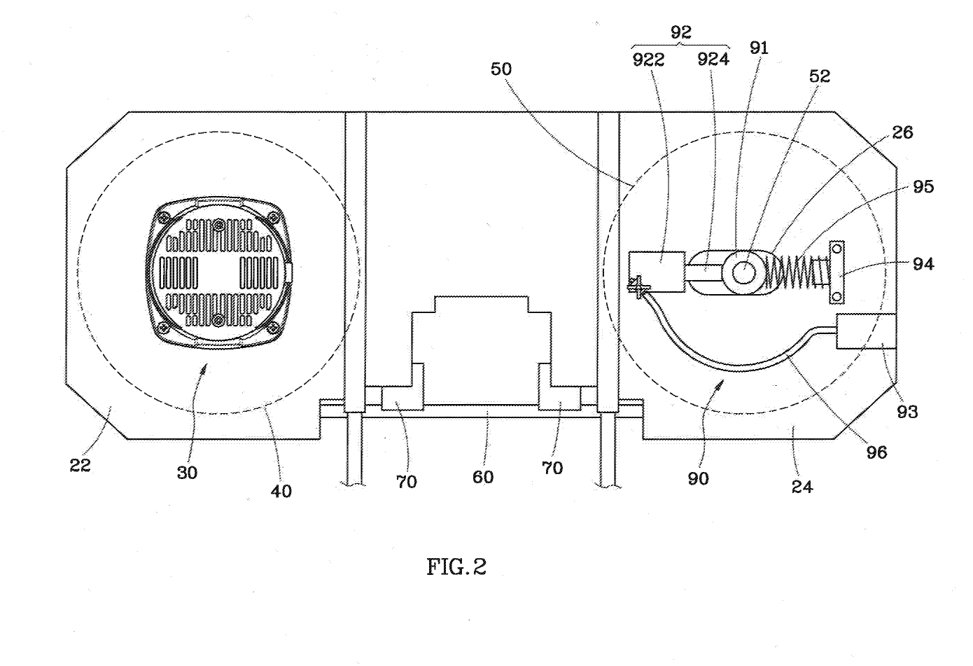

The chassis 20 includes a driving-wheel holder 22 and a driven-wheel holder 24 relative to the driving-wheel holder 22. The driven-wheel holder 24 is provided with a slot 26 as shown in FIG. 2.

The motor 30 is installed to a backside of the driving-wheel holder 22, as shown in FIG. 2, for serving as a power source and includes a driving shaft 32 extending into the driving-wheel holder 22.

The driving wheel 40 is mounted inside the driving-wheel holder 22 and connected with the driving shaft 32 to be driven by the motor 30 for rotation.

The driven wheel 50 is rotatably mounted inside the driven-wheel holder 25 via a rotary shaft 52 relative to the driving wheel 40.

The band saw 60 runs on the driving wheel 40 and the driven wheel 50 for cutting a workpiece (not shown).

Each of the band-saw regulators 70 is fixed to the chassis 20 and located between the driving wheel 30 and the driven Wheel 40 and includes a bottom end pushed against the band saw 60 for adjusting the moving trajectory of the band saw 60.

Each of the vibration sensors 72 is an accelerometer in this embodiment and fixed to a surface of the band-saw regulator 70 for sensing the vibration of the band-saw regulator 70 generated in the process of cutting and thus emitting a sensing signal. It is to be noted that the vibration sensor 72 can be only one in number subject to the band-saw regulator 70.

The control system 80 is mounted to the chassis 20 and electrically connected with the motor 30 and the two vibration sensors 72 for receiving the sensing signal of each vibration sensor 72 and thus controlling the rotational speed of the motor 30.

To adjust the tension of the band saw 60 properly, the band saw machine 10 of the present invention further includes a tension regulator 90, as shown in FIG. 2. The tension regulator 90 includes a slide member 91, a hydraulic cylinder 92, a storage member 93, a stop member 94, and a resilient member 96. The hydraulic cylinder 92 has a cylinder body 922 and a piston rod 924. The cylinder body 922 is fixed to a backside of the driven-wheel holder 24. The piston rod 924 has two ends, one of which is mounted inside the cylinder body 922 and the other is pushed against the slide member 91, while it is extending, to make the driven wheel 50 move along the slot 26 via the slide member 91 relative to the driving wheel 40 for tightening or loosing the band saw 60. The storage member 93 is fixed to a backside of the chassis 20 for storage of hydraulic fluid and connected with the cylinder body 922 via an oil pipeline 96 for transporting the hydraulic fluid to the cylinder body 922 to force the piston rod 924 to prolong. The stop member 94 is fixed to the backside of the chassis 20. The resilient member 95 is mounted between the slide member 91 and the stop member 94 for pushing the slide member 91 to drive the driven wheel 50 to move toward the cylinder body 72 and thus for conveniently loosing the band saw 60.

In light of the structure mentioned above, when the driving wheel 40 is driven by the motor 30 for rotation, the band saw 60 can be hauled synchronously to further drive the driven wheel 50 to rotate synchronously, thus making the band saw 60 keep running on the driving wheel 40 and the driven wheel 50 and cut the workpiece stably under the guidance of the hand-saw regulators 70. In the process of cutting the workpiece, the band saw 60 can transfer the vibration to certain degree subject to the material that the workpiece is made of to each of band-saw regulators 70; meanwhile, the vibration sensors 72 can sense the vibration of the band-saw regulators 70 to emit a sensing signal to the control system 80. If the vibration is less, the control system 80 will increase the rotational speed of the motor 30 to speed up the cutting speed of the band saw 60. If the vibration is greater, the control system 80 will decrease the rotational speed of the motor 30 to slow down the cutting speed of the band saw 60. In other words, the control system 80 can adjust the power output from the motor 30 to the driving wheel 40 according to the received sensing signal for adjusting the cutting speed of the band saw 60 in real time to maintain the force required for the cutting

In conclusion, the band saw machine 10 of the present invention monitors the vibration generated while the band saw 60 is cutting by means of the vibration sensors 72 to make feedback of the sensed value to the control system 80 to make the control system 80 adjust the power output from the motor 30 to the driving wheel 50 automatically. In this way, the cutting precision and service life of the band saw 60 can be enhanced to reach the goal of the present invention.

What is claimed is:

1. A band saw machine capable of automatically regulating cutting speed, comprising:
a chassis;
a motor mounted to the chassis and having a driving shaft;
a driving wheel rotatably mounted to the chassis and connected with the driving shaft to be driven by the motor for rotation;
a driven wheel rotatably mounted to the chassis relative to the driving wheel;
a band saw running on the driving and driven wheels;
at least one band-saw regulator mounted to the chassis and located between the driving and driven wheels and pushed against the band saw;
at least one vibration sensor mounted to a surface of the band-saw regulator for sensing vibration of the band-saw regulator generated in the process of cutting and thus emitting a sensing signal; and
a control system electrically connected with the motor and the at least one vibration sensor for receiving the sensing signal from the at least one vibration sensor and thus controlling power output of the motor to the driving wheel according to the sensing signal.

2. The band saw machine as defined in claim 1, wherein at least one band-saw regulator is two in number and the at least one vibration sensor is two in number, the two vibration sensors being mounted to the two band-saw regulators, respectively.

3. The band saw machine as defined in claim 1, wherein the chassis further comprises a slot and the band saw machine further comprises a tension regulation device, the tension regulation device having a slide member, a hydraulic cylinder, and a storage member, the slide member being slidably mounted inside the slot and connected with the driven wheel, the hydraulic cylinder having a cylinder body and a piston rod, the cylinder body being fixed to the chassis, the piston rod having two ends, one of which is mounted to the cylinder body and the other is pushed against the slide member, the storage member being connected with the cylinder via an oil pipeline.

4. The band saw machine as defined in claim 3, wherein the tension regulation device further comprises a stop member and a resilient member, the stop member being fixed to the chassis, the resilient member being mounted between the slide member and the stop member for pushing the driven wheel toward the hydraulic cylinder.
